(19) United States
(12) Patent Application Publication
(10) Pub. No.: US 2017/0323441 A1
(43) Pub. Date: Nov. 9, 2017

(54) FILTER-FREE DEVICES AND SYSTEMS FOR MEASURING FLUORESCENCE OF A MICROFLUIDIC ASSAY AND ASSOCIATED METHODS OF USE

(71) Applicant: University of Washington, Seattle, WA (US)

(72) Inventors: Kamal Shah, Seattle, WA (US); Koji Abe, Seattle, WA (US); Peter C. Kauffman, Bainbridge Island, WA (US)

(21) Appl. No.: 15/589,804

(22) Filed: May 8, 2017

Related U.S. Application Data
(60) Provisional application No. 62/333,565, filed on May 9, 2016.

(51) Int. Cl. G06T 7/00; G06T 7/90; H04N 5/225

(52) U.S. Cl. CPC G06T 7/0012; H04N 5/2256; G06T 7/90; G06T 2207/30004; G06T 2207/30242

(57) ABSTRACT

The present technology relates generally to devices, systems, and methods for detecting an analyte from a microfluidic assay. In some embodiments, a method for detecting the analyte includes binding an analyte and a plurality of quantum dots to a detection region of a porous membrane of a microfluidic device. The method further includes emitting ultraviolet (“UV”) light from a light source towards the microfluidic device and simultaneously capturing RGB image data of the microfluidic device with an image sensor of a portable computing device without an optical filter. The method further includes quantifying the amount of analyte present on the porous membrane based on the image data.

### CROSS-REFERENCE TO RELATED APPLICATION(S)

The present application claims the benefit of U.S. Provisional Patent Application No. 62/333,565, filed May 9, 2016, which is incorporated by reference herein in its entirety.

### STATEMENT REGARDING FEDERALLY SPONSORED RESEARCH

This invention was made with government support under Grant No. 1450187, awarded by the National Science Foundation (NSF). The government has certain rights in the invention.

### TECHNICAL FIELD

The present technology relates generally to systems and methods for assaying one or more analytes within a biological sample. Many embodiments of the present technology relate to systems and methods for measuring fluorescence of a microfluidic assay and associated methods of use.

### BACKGROUND

Diagnosis is the first hurdle in disease management, enabling expedited appropriate treatment in developed settings where sophisticated equipment and trained personnel are available. For example, in the United States, in-vitro diagnostic procedures represent about 1.6% of Medicare spending, yet influence 60-70% of medical decisions. Unfortunately, this state of the art is also expensive and complex, requiring infrastructure and instrumentation not available in all settings.

Point-of-care (POC) diagnostic assays have the potential to reduce the cost and time of diagnostic tests compared to extant laboratory-based assays. Lateral flow assays (LFAs) are especially suited for the POC due to their ease-of-use, low cost, and short time to receive results. However, quantifying the output of LFAs typically requires either a proprietary reader, such as those marketed by Qiagen and Mobile Assay, or a bulky scanner/computer. Despite the use of these complex devices to quantify LFA output, many LFAs for the POC suffer from poor limits of detection (20 nM of analyte) and small dynamic ranges (typically 2 orders of magnitude) due to the use of chromophoric detection labels, such as gold nanoparticles. In particular, analytical sensitivities of protein assays (e.g., influenza) are worse than nucleic acid tests and, according to the U.S. Center for Disease Control, do not meet the clinical range. Over the last few years, there have been demonstrations of improvement in LFA sensitivity by using fluorescent labeling of detection antibodies, but the added complexity of detection has restricted this approach to complex, instrumented systems.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1A is a top schematic view of a detection dongle coupled to a portable imaging device and configured in accordance with embodiments of the present technology.

FIG. 1B is a circuit diagram of the integrated circuit of the detection dongle of FIG. 1A.

FIG. 2 is an isometric schematic view of a lateral flow assay configured for use with the detection assembly in accordance with embodiments of the present technology.

FIG. 3 is a graph showing the spectral sensitivity of a Nexus 5X smartphone.

FIG. 4 is a graph showing the Stokes shift of quantum dots when excited by UV light.

FIG. 5 is a schematic diagram showing a series of photographs of lateral flow assays containing increasing concentrations of analyte, and a graph plotting the ratiometry at each concentration.

FIG. 6 is a plot showing the lowest detectable concentration of analyte using the detection dongle at different illuminance conditions.

### DETAILED DESCRIPTION

The present technology is generally related to devices, systems and methods for assaying one or more analytes of a fluid sample using fluorescence. In some embodiments, a method for detecting an analyte includes binding an analyte and a plurality of quantum dots to a detection region of a porous membrane of a microfluidic device. The method further includes emitting ultraviolet (“UV”) light from a light source towards the microfluidic device and simultaneously capturing RGB image data of the microfluidic device with an image sensor of a portable computing device. The method further includes quantifying the amount of analyte present on the porous membrane based on the image data and without using an optical filter in addition to those integrated with the portable computing device.

### I. Definitions

As used herein, the term “porous membrane” or “porous substrate” or “substrate” refers to a material through which fluid can travel by capillary action. Representative examples of such porous membranes include glass fiber, paper, nitrocellulose, nylon, cellulose, and many other materials recognized by those skilled in the art as capable of serving as a wick in the context of the present technology. In some embodiments, all or part of the porous membrane may include a cellulose ester or a polymeric material (e.g., polyether sulfone (“PES”), polysulfone (“PS”), polyether sulfone (“PES”), polyacrilonitrile (“PAN”), polyamide, polyimide, polyethylene (“PE”), polypropylene (“PP”), polytetrafluoroethylene (“PTFE”), polyvinylidene fluoride (“PVDF”), polyvinylchloride (“PVC”). The porous membrane can be two-dimensional or three-dimensional (when considering its height in addition to its length and width). In some embodiments, the porous membrane is a single layer, while in other embodiments, the porous membrane comprises two or more layers of membrane.

As used herein, a “biological sample” can be any solid or fluid sample, living or dead, obtained from, excreted by, or secreted by any living or dead organism, including, without limitation, single-celled organisms, such as bacteria, yeast, protozoans, amoebas, multicellular organisms (such as plants or animals, including samples from a healthy or apparently healthy human subject or a human patient affected by a condition or disease to be diagnosed or investigated, such as tuberculosis) and/or soil. Biological samples can include one or more cells, proteins, nucleic acids, etc., as well as one or more buffers. Biological samples can be a liquid phase solution of cells or it may be a solid cell sample such as a cell pellet derived from a centrifugation procedure. As used herein, a “cell” or “cells” can refer to eukaryotic cells, prokaryotic cells, viruses, endospores or any combination thereof. Cells thus may include bacteria, bacterial spores, fungi, virus particles, single-celled eukaryotic organisms (e.g., protozoans, yeast, etc.), isolated or aggregated cells from multi-cellular organisms (e.g., primary cells, cultured cells, tissues, whole organisms, etc.), or any combination thereof, among others.

### II. Selected Embodiments of Detection Assemblies and Methods of Use

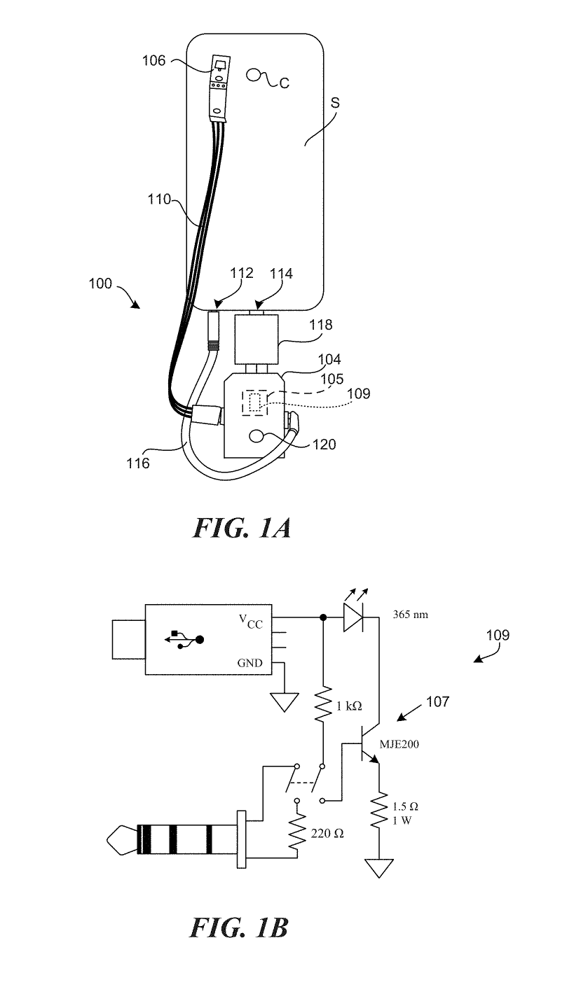

FIG. 1A is a top view of a detection dongle 100 (the “dongle 100”) coupled to a portable imaging device and configured in accordance with some embodiments of the present technology. The imaging device shown in FIG. 1A is a smartphone S having a camera C. In other embodiments the imaging device can be any portable device that includes (a) a processor and (b) an image sensor coupled to the processor and configured to generate image data (e.g., pixels containing RGB color data). Suitable imaging devices include, for example, a portable scanner, a tablet, a laptop, etc. Accordingly, it will be appreciated that although the dongle 100 is described below with reference to smartphone S, the dongle 100 may be coupled to/used with any suitable imaging device.

As shown in FIG. 1A, the dongle 100 includes a board 104 configured to be detachably or permanently coupled to the smartphone S, and a light source 106 configured to be detachably or permanently coupled to the board 104 via connector 110. The board 104 may be configured to be coupled to the auxiliary port 112 (i.e., headphone jack) of the smartphone S and/or the USB port 114 of the smartphone S. For example, the dongle 100 may include a connector 116 (e.g., an auxiliary audio cable) for coupling the board 104 to the auxiliary port 112, and a connector 118 for coupling the board 104 to the smartphone's USB port 114. In some embodiments, the connector 118 may be a USB and/or micro-USB connector (e.g., USB type A connector, USB type B connector, USB type C connector, etc.) and/or a USB adaptor (as shown in FIG. 1A). In some embodiments, the board 104 may plug directly into the smartphone's USB port 114 without a separate connector. The board 104 and the light source 106 may be coupled to one another via other suitable connectors and/or connection configurations. Likewise, the board 104 and/or the light source 106 may be coupled to the smartphone S via other suitable connectors and/or connection configurations. For example, in some embodiments the light source 106 may be directly coupled to the smartphone S without the board 104 and/or other intermediate device therebetween.

The light source 106 is configured to emit UV light. For example, in some embodiments the light source 106 is a light-emitting diode (“LED”) configured to emit UV light, such as a 365 nm LED (Lite-On LTPL-0034UVH365). In some embodiments, the light source 106 emits light primarily in the UV-A spectrum to reduce health risks. The light source 106 may be powered by the smartphone S (e.g., via the USB connection through the board 104), or may be powered by a separate power source. As shown in FIG. 1A, the light source 106 may be movable with respect to the smartphone S and/or board 104 when the light source 106 is coupled to the smartphone S and/or the board 104. In some embodiments, however, the light source 106 may be fixed to the smartphone S and/or the board 104.

As shown in FIG. 1A, the board 104 may include a printed circuit board (“PCB”) 105 (shown schematically) having an integrated circuit 109 (“IC 109”) and a button 120 (shown schematically) coupled to the IC 109. One example of a circuit diagram for the IC 109 is shown schematically in FIG. 1B. Referring to FIGS. 1A and 1B together, the button 120 may be a double-pole, single throw (“DPST”) button or other suitable means for translating a user's physical touch to an electrical signal. In some embodiments, the smartphone S may include a camera application (factory installed or downloadable) that allows the user to take a photo by pressing the smartphone's volume button. When the dongle 100 is assembled with the smartphone S, the IC 109 may be coupled to the camera C of the smartphone S as well as the light source 106. Pressing the button 120 toggles an NPN transistor 107 (FIG. 1B) of the IC 109, thereby powering the light source 106 and providing an impedance (e.g., 220 Ω) across the connector 116 that has the same effect as pressing the volume button of the smartphone S. Thus, when the camera application is open on the smartphone S and the user presses the button 120, the impedance generated by the IC 109 triggers the smartphone camera C shutter. As such, pressing the button 120 simultaneously causes (a) the light source 106 to emit UV light and (b) the camera C of the smartphone S to take a picture, thereby capturing image data of the target while illuminated at least by the UV light.

One feature of a dongle 100 configured in accordance with the present technology is its low cost. For example, it is expected that the dongle's components will cost less than $5. Another feature of the dongles described herein are their size. In particular, dongle 100 components are expected to weigh only about 22 grams and occupy less than 20 cm³. Such features for the dongle 100 are particularly beneficial in POC settings.

The analytical sensitivities of conventional protein LFAs (such as influenza LFAs) are lacking as compared to the analytical sensitivities of conventional LFAs for other analytes, such as nucleic acid LFAs. To address this need, the detection dongle 100 of the present technology may be used with quantum dot LFAs to quantify LFA output (such as protein detection) by measuring the fluorescence of the quantum dots. The detection dongle 100 of the present technology is especially beneficial as the analyte detection and/or quantification can be carried out in ambient light (in contrast to a dark room setting) and without the use of any of the smartphone's integrated optical filters.

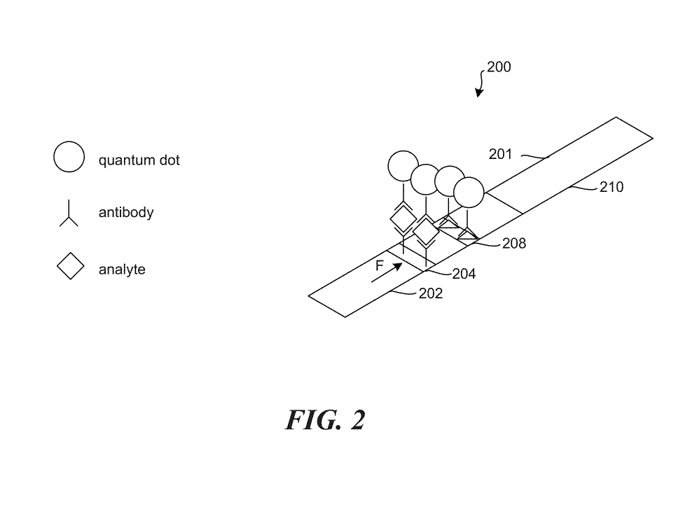

FIG. 2 shows one example of a quantum-dot LFA 200 (“LFA 200”) configured for use with the detection dongle 100 of the present technology. As shown in FIG. 2, the LFA 200 may be a two-site non-competitive assay, also known as a sandwich assay, that includes a porous substrate 201, an antibody, an analyte, and quantum dots as the fluorophore (i.e., detectable label). In some embodiments, such as that shown in FIG. 2, the substrate 201 is nitrocellulose, the antibody is biotin-mouse anti-flu A nucleoprotein IgG, and the analyte is H3N2 flu A nucleoprotein. The quantum dots may have a 605 nm peak emission. In other embodiments, the quantum dots may be cadmium selenide quantum dots, streptavidin quantum dots, and/or other suitable quantum dots. It will appreciated that other antibodies may be used and/or other analytes (including other protections and nucleic acids) may be detected using the dongle 100 (FIG. 1A) so long as quantum dots are used as the detectable label. Likewise, the detection dongle 100 may be used with any type of assay, such as a competitive, homogeneous assay, a competitive heterogeneous assay, a one-site non-competitive assay, and/or other suitable assays. In some embodiments, one or more of the components of the LFA (other than the sample containing the analyte) are provided together with the dongle 100 at the POC. In other embodiments, one or more of the LFA components may be provided separately.

As shown in FIG. 2, the substrate 201 may include an upstream or input region 202 configured to receive a fluid sample (such as a biological sample) containing the analyte. In some embodiments, for example, the input region 202 is configured to receive about 20 μL. The substrate 201 further includes a detection region 204, a control region 208 downstream of the detection region 204, and a receiving region 210 (e.g., a wicking pad) downstream of the control region 208. The detection region 204 includes an antibody bound thereto, while the control region 208 does not have any bound antibody. In use, the sample is delivered to the input region 202 and wicked downstream (as indicated by arrow F) through the detection region 204 and the control region 208 to the receiving region 210. As the sample travels through the detection region 204, at least some of the analyte binds to the antibody and remains trapped within the detection region 204. Although the control region 208 does not include antibody, a trace amount of analyte may non-selectively bind or otherwise remain within the control region 208. A solution containing antibody labelled with quantum dots is then delivered to the input region 202 and flowed through the substrate 201 to the receiving region 210. As the quantum dot-labeled antibody flows through the detection and control regions 204, 208, the antibody binds the analyte present in the detection region and control regions 204, 208, thereby labelling the analyte with the quantum dots.

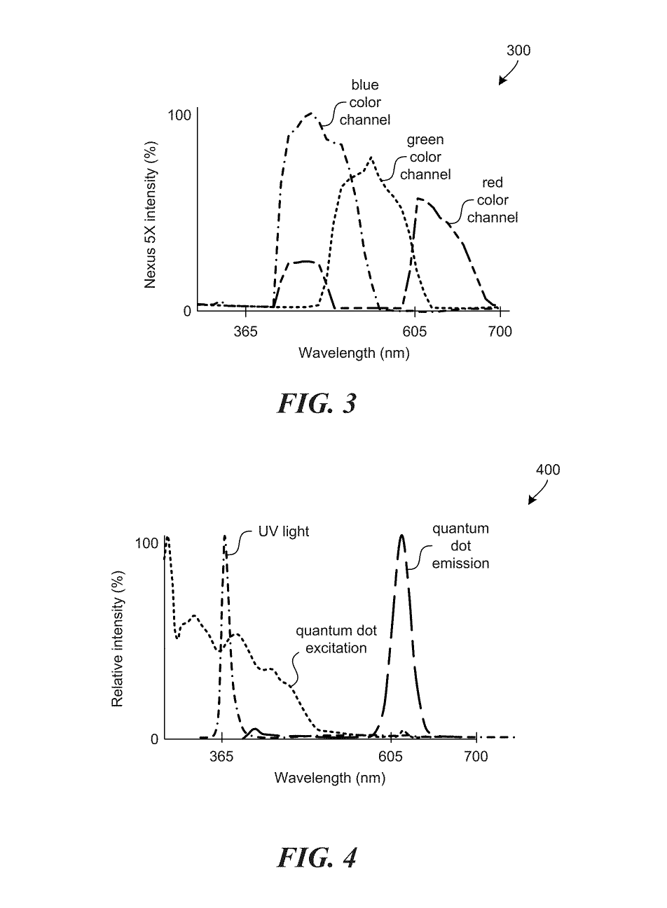

As this stage, the user may position the dongle 100 and smartphone S assembly (FIG. 1A) an appropriate distance from the LFA 200 and press the button 120 to emit UV light onto the LFA and, while the UV light is being emitted, capture image data of the LFA. The emitted UV light excites the quantum dots and causes the quantum dots to emit light that is captured by the camera C of the smartphone S. To distinguish between the fluorescence excitation light (UV light) and emission light (the light emitted by the quantum dots) within the captured image data, methods of the present technology utilize the smartphone's S ability to independently quantify red, green, and blue light. Such quantification of the red, green, and blue light is sometimes referred to as the red color channel, green color channel, and blue color channel, respectively. For example, FIG. 3 is a graph 300 showing the spectral sensitivity of a Nexus 5X smartphone. As shown in FIG. 3, the blue color channel has peak sensitivity at lower wavelengths than the green color channel and the green color channel has peak sensitivity at lower wavelengths than the red color channel. The blue color channel predominantly detects blue light, the green color channel predominantly detects green and yellow light, and the red color channel predominantly detects orange and red light (the red color channel also detects some blue light).

FIG. 4 is a graph 400 showing relative fluorescence intensity versus wavelength of UV light, quantum dot excitation light, and quantum dot emission light. As demonstrated by the graph 400, quantum dots may be especially beneficial for distinguishing excitation and emission light because the Stokes' shift (i.e., the difference in wavelength units between the absorption band maximum and the emission band maximum) for quantum dots is large enough to consistently and easily quantify the shift. The excitation light emitted by the quantum dots (in response to the UV light) is visualized by the blue color channel of smartphone image data and/or photographs. In some embodiments, for example, the size of the quantum dots may be selected for a desired peak fluorescence emission to improve ease of analyte detection and analysis. For example, quantum dots with a peak emission at 605 nm may be beneficial as 605 nm is primarily within the red color channel of most camera sensors, as demonstrated by the overlap between the red color channel spectrum in FIG. 3 and the quantum dot emission spectrum in FIG. 4. Moreover, as shown in FIGS. 3 and 4, the blue channel color spectrum (FIG. 3) overlaps with the UV light spectrum (FIG. 4). As such, quantum dots having a peak emission at 605 nm may be used to maximize the Stokes' shift and the overlap between the quantum dot emission spectrum and the red color channel while simultaneously minimizing overlap with the blue color channel spectrum. In those embodiments utilizing nitrocellulose as the substrate 201, the blue color channel of the image data provides a reference to account for non-uniform excitation and ambient light, since nitrocellulose autofluorescence emits at blue-green wavelengths and the light source 106 (FIG. 1A) emits at UV wavelengths (FIG. 4).

To account for potential variations in illumination levels, the present technology utilizes a ratiometric quantity consisting of the average red channel intensity divided by the average blue channel intensity, which is believed to be proportional to the concentration of quantum dot-labeled analyte. The present technology also compensates for nonspecific binding of quantum dots by subtracting the ratio of the control region 208 from that of the detection region 204 (FIG. 2), as shown in Equation 1:

$$Ratio = \frac{{Red}_{capture region}}{{Blue}_{capture region}} - \frac{{Red}_{downstream background region}}{{Blue}_{downstream background region}}$$

Thus, the ratio of the red to the blue color channels of the photograph (or image data) of the detection region 204 provides a quantitative readout of the LFA 200 independent of ambient light levels while eliminating the need for costly optical filters. The ratiometric approach (Equation 1) of the present technology yielded a limit of detection of 100 pM in nonzero, non-uniform ambient light levels and a dynamic range spanning 3.5 orders of magnitude. The limit of detection disclosed herein shows a greater than 6× sensitivity improvement over prior sandwich lateral flow assays, including those using ratiometric imaging of fluorescent labels using mobile device cameras. Without being bound by theory, the inventors believe that the ratiometric subtraction of the local downstream background region as presented herein is responsible for much (if not all) of this sensitivity improvement over prior devices and techniques. In other words, the ratiometric subtraction compensates for both differences in illumination and in nonspecific binding between individual lateral flow strips and between photos, whereas prior work in mobile ratiometry accounted solely for differences in illumination between photos without explicitly compensating for nonspecific binding.

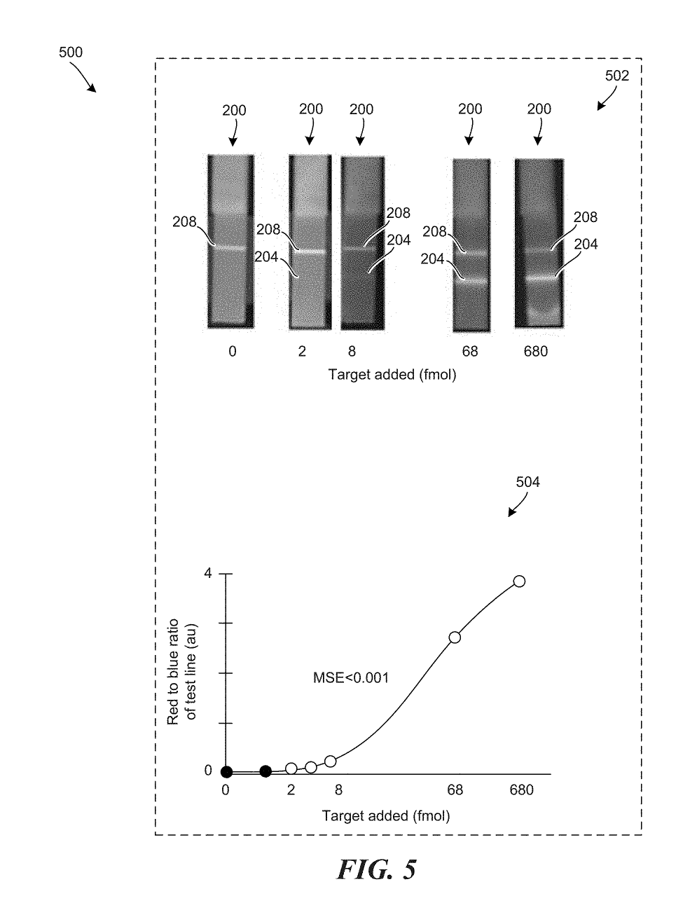

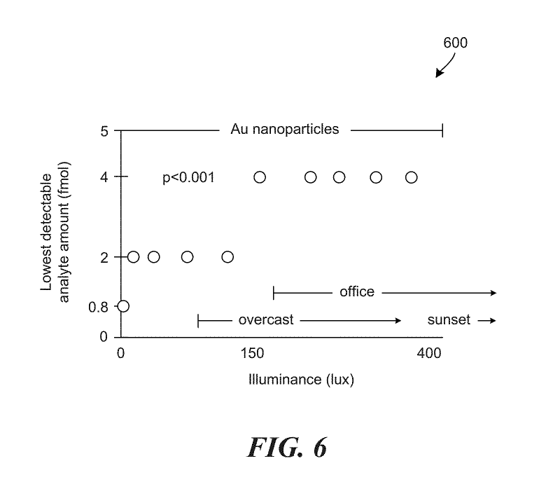

FIG. 5 is a schematic diagram 502 showing a series of photographs of LFAs 200 containing increasing concentrations of a protein analyte, and a graph 504 plotting the red/blue ratio of the detection region 204 at each concentration using devices and methods of the present technology. The effect of ambient illumination was assessed by illuminating the dried substrates with a 75 W soft white (Phillips 2700K, 3 klm) light bulb at an angle 60° above the horizontal at distances up to 3 meters, thereby simulating the ambient illumination present in indoor point-of-care usage. Illuminance at the substrates was measured with a zero-biased photodiode (Osram SFH-2430) connected to a picoammeter (Keithley Instruments 414A) with radiant incident angle correction. As shown in FIG. 5, the lowest detectable analyte levels were lower than the lowest reported gold nanoparticle limit of detection in literature (e.g., 5 fmol) for all tested illuminance levels (up to 400 lux)(see also FIG. 6). In particular, the limit of detection using the devices and methods of the present technology was 0.86 fmol, which is about 6× better than the limit of detection of gold nanoparticle-based LFAs reported in the literature (i.e., 5 fmol). Moreover, the dynamic range using the devices and methods of the present technology spanned 2.9 orders of magnitude, which is better than the dynamic range of gold nanoparticle-based LFAs reported in the literature (i.e., 2.5 orders of magnitude). For example, FIG. 6 is a plot 600 showing the lowest detectable concentration of analyte using the detection dongle. As outlined in FIG. 6, the lowest detectable concentration was better than gold nanoparticles under illumination with ambient light. This is because fluorescence measurements (such as with quantum dots) are usually intrinsically more sensitive than absorbance-based measurements (such as with gold nanoparticles) due to the higher signal-to-background ratios associated with fluorescence. In fluorescence measurements, the signal of interest is typically much greater than the undesired background signal (high signal-to-background ratio), whereas in absorbance measurements, the signal of interest is typically small compared to a relatively high background signal (low signal-to-background ratio).

### III. Conclusion

From the foregoing, it will be appreciated that specific embodiments of the technology have been described herein for purposes of illustration, but that various modifications may be made without deviating from the technology. Additionally, other embodiments of the present technology can have different configurations, components, and/or procedures than those described herein. For example, other embodiments can include additional elements and features beyond those described herein, or other embodiments may not include several of the elements and features shown and described herein. Moreover, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein. Thus, the disclosure is not limited except as by the appended claims.

I/We claim:

1. A method for detecting an analyte, the method comprising:
binding an analyte and a plurality of quantum dots to a detection region of a porous membrane of a microfluidic device;
capturing RGB image data of the microfluidic device with an image sensor of a portable computing device while emitting ultraviolet (“UV”) light from a light source towards the microfluidic device, wherein the RGB image data is captured without the use of the optical filters integrated with the portable computing device; and
based on the image data, quantifying the amount of analyte present on the porous membrane.

2. The method of claim 1 wherein emitting UV light includes emitting UV light from an LED detachably coupled to the portable computing device via an electrical connector.

3. The method of claim 1 wherein quantifying the amount of analyte includes detecting an amount of fluorescent light emitted by the quantum dots in response to the emitted UV light.

4. The method of claim 1 wherein the RGB image data includes data characterizing red light, green light, and blue light, and wherein the method further comprises:
determining a ratio of an average intensity of the red light within the detection region to an average intensity of the blue light within the detection region,
and wherein quantifying the amount of analyte includes determining the ratio of the average intensity of the red light to the average intensity of the blue light.

5. The method of claim 1 wherein the microfluidic device includes a control region separate from the detection region and the control region does not bind the analyte, and wherein the method further comprises:
binding at least some quantum dots to the control region,
wherein the RGB image data includes data characterizing red light, green light, and blue light, and wherein the method further comprises:
determining a first ratio, the first ratio being a ratio of an average intensity of the red light within the detection region to an average intensity of the blue light within the detection region,
determining a second ratio, the second ratio being a ratio of an average intensity of the red light within the control region to an average intensity of the blue light within the control region, and
quantifying the amount of analyte includes subtracting the second ratio from the first ratio.

6. The method of claim 1 wherein quantifying the amount of analyte includes visualizing a fluorescence of the portion of the analyte bound to the quantum dots.

7. The method of claim 1 wherein capturing RGB image data occurs under ambient light conditions.

8. The method of claim 1 wherein capturing RGB image data occurs in partially darkened conditions.

9. The method of claim 1 wherein capturing RGB image data occurs in the dark.

10. The method of claim 1 wherein the microfluidic device is a lateral flow assay strip.

11. The method of claim 1 wherein the portable computing device is a smartphone.

12. The method of claim 1 wherein the portable computing device is a tablet.

13. The method of claim 1, further comprising powering the light source with the portable computing device.

14. A method for detecting an analyte, the method comprising:
delivering a plurality of quantum dots to a detection region of a porous membrane of a microfluidic device;
delivering an analyte to the detection region;
binding at least a portion of the analyte to at least some of the quantum dots;
under ambient light conditions, capturing RGB image data of the detection region with an image sensor of a portable computing device while emitting UV light towards the microfluidic device from a light source;
based on the RGB image data, determining a ratio of an intensity of red light within the detection region and to an intensity of blue light within the detection region; and
based on the ratio, quantifying the amount of analyte present on the porous membrane.

15. The method of claim 14 wherein emitting UV light includes emitting UV light from an LED detachably coupled to the portable computing device via an electrical connector.

16. The method of claim 14 wherein quantifying the amount of analyte includes detecting an amount of fluorescent light emitted by the quantum dots in response to the emitted UV light.

17. The method of claim 14 wherein the determined intensity of the red light is an average intensity, and wherein the determined intensity of the blue light is an average intensity.

18. The method of claim 14 wherein:
the microfluidic device includes a control region separate from the detection region,
the control region does not bind the analyte,
the ration is a first ratio, and
the method further comprises:
binding at least some quantum dots to the control region,
determining a second ratio, the second ratio being a ratio of an intensity of the red light within the control region to an average intensity of the blue light within the control region, and
quantifying the amount of analyte includes subtracting the second ratio from the first ratio.

19. The method of claim 14 wherein quantifying the amount of analyte includes visualizing a fluorescence of the portion of the analyte bound to the quantum dots.

20. The method of claim 14 wherein the microfluidic device is a lateral flow assay strip.

21. The method of claim 14 wherein the portable computing device is a smartphone.

22. The method of claim 14 wherein the portable computing device is a tablet.

23. The method of claim 14, further comprising powering the light source with the portable computing device.
